(19) United States
(12) Patent Application Publication
(10) Pub. No.: US 2025/0149954 A1
(43) Pub. Date: May 8, 2025

(54) AXIAL FLUX MACHINE, ELECTRIC AXLE DRIVETRAIN, AND MOTOR VEHICLE

(71) Applicant: Schaeffler Technologies AG & Co. KG, Herzogenaurach (DE)

(72) Inventors: Benjamin Stober, Forstfeld (FR); Stefan Rieß, Kaufering (DE)

(73) Assignee: Schaeffler Technologies AG & Co. KG, Herzogenaurach (DE)

(21) Appl. No.: 18/837,982

(22) PCT Filed: Feb. 2, 2023
(86) PCT No.: PCT/DE2023/100083

§ 371 Date: Aug. 13, 2024

(30) Foreign Application Priority Data
Feb. 14, 2022 (DE) 10 2022 103 386.4
Jun. 9, 2022 (DE) 10 2022 114 472.0

(51) Int. Cl. H02K 9/193

(52) U.S. Cl. CPC H02K 9/193

(57) ABSTRACT

An axial flux machine includes a rotor mounted rotatably relative to a stator. The stator has at least one first disc-shaped stator body, and the rotor and also the first stator body are arranged such that a first magnetically active gap running in a radial plane is formed axially between the first stator body and the rotor. The stator is surrounded at least in portions by a motor housing; a ring-segment-shaped groove which is open towards the first stator body and extends in a radial plane is formed; and a plurality of cooling openings are provided in the motor housing in the region of the ring-segment-shaped groove, by means of which cooling openings a cooling fluid that can be introduced into the ring-segment-shaped groove can be applied to the first stator body.

### CROSS-REFERENCE TO RELATED APPLICATIONS

This application is the U.S. National Phase of PCT Appln. No. PCT/DE2023/100083 filed Feb. 2, 2023, which claims priority to DE 10 2022 103 386.4 filed Feb. 14, 2022 and DE 10 2022 114 472.0 filed Jun. 9, 2022, the entire disclosures of which are incorporated by reference herein.

### TECHNICAL FIELD

The present disclosure relates to an axial flux machine, comprising a rotor rotatably mounted relative to a stator, wherein the stator has at least one first disc-shaped stator body, and the rotor and also the first stator body are arranged such that a first magnetically effective gap a running in a radial plane is formed axially between the first stator body and the rotor, and the stator is surrounded at least in sections by a motor housing. The disclosure also relates to an electric axle drive train and a motor vehicle.

### BACKGROUND

Electric motors are increasingly being used to drive motor vehicles in order to create alternatives to internal combustion engines that require fossil fuels. Significant efforts have already been made to improve the suitability of electric drives for everyday use and also to be able to offer users the driving comfort they are accustomed to.

A detailed description of an electric drive can be found in an article in the German automotive magazine ATZ, volume 113, May 2011, pages 10-14 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged so as to be concentric and coaxial with respect to a bevel gear differential, wherein a shiftable 2-speed planetary gear set is arranged in the drive train between the electric motor and the bevel gear differential and likewise positioned to be coaxial with the electric motor and the bevel gear differential or spur gear differential. The drive unit is very compact and allows for a good compromise between climbing ability, acceleration and energy consumption due to the shiftable 2-speed planetary gear set. Such drive units are also referred to as e-axles or electrically operable drive trains.

In addition to purely electrically operated drive trains, hybrid drive trains are also known. Such drive trains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, it is also possible to use the internal combustion engine and the electric motor at the same time for driving purposes in certain operating situations.

An axial flux machine is a dynamo-electric machine in which the magnetic flux between the rotor and stator runs parallel to the rotational axis of the rotor. Often, both the stator and the rotor are designed to be largely disc-shaped. Axial flux machines are particularly advantageous when the axially available installation space is limited in a given application. This is often the case, for example, with the electric drive systems for electric or hybrid vehicles described at the outset.

In addition to the shortened axial installation length, a further advantage of the axial flux machine is its comparatively high torque density. The reason for this is, compared to radial flux machines, the larger air gap area which is available for a given installation space. Furthermore, a lower iron volume is required compared to conventional machines, which has a positive effect on the efficiency of the machine.

Typically, an axial flux machine comprises at least one stator having windings for generating the axially aligned magnetic field. At least one rotor is equipped with permanent magnets, for example, the magnetic field of which interacts with the magnetic field of the stator windings in order to generate a drive torque over an air gap.

In the development of electric machines intended for e-axles and hybrid modules, there is a continuing need to increase their power densities, so the cooling of axial flux machines required for this is growing in importance. Owing to the necessary cooling capacities, hydraulic fluids such as cooling oils have become established in most concepts for the removal of heat from the thermally loaded regions of an electric machine. Nevertheless, these cooling strategies are often inadequate and/or involve high technical implementation costs.

### SUMMARY

It is therefore the object of the disclosure to eliminate or at least mitigate the problems known from the prior art and to provide an axial flux machine with an effective and inexpensive cooling system.

This object is achieved by an axial flux machine, comprising a rotor rotatably mounted relative to a stator, wherein the stator has at least one first disc-shaped stator body, and the rotor and also the first stator body are arranged such that a first magnetically effective gap running in a radial plane is formed axially between the first stator body and the rotor, and the stator is surrounded at least in sections by a motor housing, wherein a ring-segment-shaped groove which is open towards the first stator body and extends in a radial plane is formed on the motor housing, and a plurality of cooling openings are provided in the motor housing in the region of the ring-segment-shaped groove, by means of which cooling openings a cooling fluid that can be introduced into the ring-segment-shaped groove can be applied to the first stator body.

This has the advantage that a particularly efficient cooling fluid transfer and distribution can be achieved between the motor housing and the stator of the axial flux machine. Furthermore, the cooling fluid transfer and distribution by means of the ring-segment-shaped groove also allows for a particularly compact axial design.

Furthermore, the configuration according to the disclosure allows for only the housing to be adapted for different installation space situations, but the electric machine as such can be designed identically in each case, which simplifies the installation space-specific adaptation in a corresponding manner and means that the electric machine can also be manufactured more cost-effectively.

Due to the laminar cooling of a stator via the ring-segment-shaped groove, the rotor of the electric machine can, for example, also be cooled, which further improves the cooling performance.

The ring-segment-shaped groove is located axially on one side of the axial flux machine and is open towards the axial flux machine. There are cooling openings in the housing of the axial flux machine that extend axially through the housing, allowing the cooling fluid to flow into the axial flux machine and thereby cool the first stator body of the axial flux machine.

It is understood that a ring-segment-shaped groove can also be designed as circumferentially closed.

The individual elements of the claimed subject matter of the disclosure will be explained first, after which preferred embodiments of the subject matter of the disclosure will be described.

The magnetic flux in an electric axial flux machine (AFM) according to the disclosure is directed axially to a direction of rotation of the rotor of the axial flux machine in the magnetically effective gap between the stator and the rotor. Different types of axial flux machines exist. The axial flux machine according to the disclosure can be designed as an I-type configuration. In principle, it is also possible for a plurality of rotor-stator configurations to be arranged axially adjacent as an I-type and/or H-type. It would also be possible in this context to arrange both one or more I-type rotor-stator configurations and one or more H-type rotor-stator configurations adjacent to one another in the axial direction. In particular, it is also preferable that the rotor-stator configurations of the H-type and/or the I-type are each designed essentially identically, so that they can be assembled in a modular manner to form an overall configuration. Such rotor-stator configurations can in particular be arranged to be coaxial to one another and can be connected to a common rotor shaft or to a plurality of rotor shafts.

According to a further preferred further development of the disclosure, the stator can, in particular, also comprise at least one second disc-shaped stator body, which is arranged coaxially to the first stator body and to the rotor shaft and spaced apart from the first stator body with axial interposition of one of the rotor bodies, so that an I-type configuration of an axial flux machine is implemented.

A rotor can further have a rotor shaft. A rotor shaft is a rotatably mounted shaft of an electric machine to which the rotor or rotor body is coupled in a non-rotatable manner.

In this context, it is particularly preferable for the rotor to have a rotor shaft with at least one first disc-shaped rotor body, which is arranged on the rotor shaft in a non-rotatable manner, which enables cost-efficient production by dividing the rotor into magnetically effective components (rotor body) and purely mechanical components (rotor shaft). In particular, this also makes it possible to design the various previously mentioned I-type and/or H-type configurations in a particularly flexible manner.

The rotor of an electric axial flux machine can preferably be designed at least in parts as a laminated rotor. A laminated rotor is designed to be layered in the axial direction. Alternatively, the rotor of an axial flux machine can also have a rotor carrier or rotor body which is correspondingly equipped with magnetic sheets and/or SMC material and with magnetic elements designed as permanent magnets.

A rotor can comprise a rotor body. In a preferred manner, a rotor body has an inner part via which the rotor can be connected to a shaft in a non-rotatable manner, and an outer part which delimits the rotor in a radially outward direction. The rotor body can be formed between the inner part and the outer part with several rotor struts, via which the inner part and the outer part are connected to one another and which, together with the radial outer surface of the inner part and the radial inner surface of the outer part, forms a receiving space for accommodating the magnetic elements and the flux conducting elements of the rotor. As an alternative to the receiving space, the magnetic elements can be arranged or placed on the rotor carrier.

A magnetic element can be formed as a permanent magnet in the form of a bar magnet or in the form of smaller magnet blocks. The magnetic elements are usually arranged in, at or on a rotor carrier. The magnetic element of a rotor of an axial flux machine, which is designed as a permanent magnet, interacts with a rotating magnetic field generated by the stator winding coils, which are usually supplied with a three-phase current.

The stator of an electric axial flux machine preferably has a stator body with a plurality of stator windings arranged in the circumferential direction. The stator body can be designed to be in one piece or segmented, as seen in the circumferential direction. The stator body can be formed from a laminated stator core with a plurality of laminated electrical sheets. Alternatively, the stator body can also be formed from a compressed soft magnetic material, such as what is termed an SMC (soft magnetic composite) material.

The axial flux machine can have a motor housing. The motor housing encloses the axial flux machine at least in sections, preferably completely. A motor housing can also accommodate the control and power electronics. The motor housing can furthermore be part of a cooling system for the electric machine, and can be designed in such a way that cooling fluid can be supplied to the axial flux machine via the motor housing and/or the heat can be dissipated to the outside via the housing surfaces.

A motor housing can be formed in particular from a metallic material. Advantageously, the motor housing can be formed from a metallic cast material, such as gray cast iron or cast steel. In principle, it is also conceivable to form the motor housing entirely or partially from a plastic. It is particularly preferable for the motor housing to have the basic shape of a cylindrical ring. The motor housing can be designed in one piece or multiple pieces. It can also be advantageous for one or more stator carriers to be formed in one piece with the motor housing, at least in sections, which can further improve the ease of assembly of the axial flux machine.

According to an advantageous embodiment of the disclosure, a first disc-shaped stator body and/or a second disc-shaped stator body can be designed as a circuit board, in particular as a printed circuit board, which is also referred to as a PCB, as a result of which the stator body can be manufactured in a particularly compact and cost-effective manner. In this regard, the winding of the stator body is formed in one piece with the circuit board. The circuit board is preferably a multi-layer board with a plurality of copper layers over which the stator windings extend. A further possible embodiment is to design the stator body as a sandwich of several multi-layer boards. The circuit board is preferably made of a composite of epoxy resin and glass fiber.

The axial flux machine is intended in particular for use within an electrically operable drive train of a motor vehicle. In particular, the axial flux machine is dimensioned such that vehicle speeds of more than 50 km/h, preferably more than 80 km/h and in particular more than 100 km/h can be achieved. The axial flux machine particularly preferably has an output of more than 30 kW, preferably more than 50 KW and in particular more than 70 kW. Furthermore, it is preferred that the axial flux machine provides speeds greater than 5,000 rpm, particularly preferably greater than 10,000 rpm, very particularly preferably greater than 12,500 rpm.

According to an advantageous embodiment of the disclosure, the number of cooling openings can correspond to the number of coils of the first stator body, so that efficient cooling of each individual coil can be provided.

According to a further preferred further development of the disclosure, the ring-segment-shaped groove can be hydraulically connected in a conducting manner to a cooling channel section extending outwards in the radial direction, which in turn is hydraulically connected to the output side of a heat exchanger via a hydraulic coupling means. This allows the cooling fluid to be conveyed from the heat exchanger via the cooling channel section into the ring-segment-shaped groove.

Furthermore, according to an equally advantageous embodiment of the disclosure, a pressure relief valve can be arranged between the ring-segment-shaped groove and the hydraulic coupling means, which opens into an overflow channel on the output side. The advantageous effect of this embodiment is that the hydraulic system used for stator cooling can be protected from overpressure and any potential damage resulting therefrom.

According to a further particularly preferred embodiment of the disclosure, a return channel can be formed radially outside of the first stator body, by means of which cooling fluid can be discharged from the first stator body. This, in particular, achieves the advantage that several stators can be connected to the cooling system. This can also allow for the possibility of implementing busbar cooling.

Furthermore, the disclosure can also be further developed in that the stator comprises at least one second disc-shaped stator body, which is arranged coaxially to the first stator body and spaced apart from the first stator body with axial interposition of the rotor, wherein the cooling channel section is connected at least to a first hydraulic path extending axially through the axial flux machine, so that the cooling fluid can be guided to the second disc-shaped stator body. The advantage of this embodiment is that the cooling oil can be transported axially from the first to the second stator body, wherein, however, only one hydraulic connection, namely the coupling means, is required.

In an equally preferred embodiment of the disclosure, the axial flux machine can have a second hydraulic path extending axially through the axial flux machine and connected to the cooling channel section. In this manner, the hydraulic cooling performance can be further improved and a better distribution of cooling fluid can be achieved.

It can also be advantageous to further develop the disclosure such that a second ring-segment-shaped groove which is open towards the second stator body and extends in a radial plane is formed on the motor housing, and a plurality of cooling openings are provided in the motor housing and/or on a connecting housing of superordinate structure in the region of the second ring-segment-shaped groove, by means of which cooling openings a cooling fluid that can be introduced into the second ring-segment-shaped groove can be applied to the second stator body, wherein the second groove is connected to the first hydraulic path and/or second hydraulic path, which also contributes to an improved cooling performance and cooling fluid distribution.

The object of the disclosure is further achieved by an electric axle drive train for a motor vehicle, comprising at least two axial flux machines, the rotors of which are arranged coaxially to one another. This makes it possible to drive two vehicle wheels of a vehicle axle separately with one axial flux machine each.

An electrically operable drive train thus comprises two electric axial flux machines and preferably, in each case, one transmission arrangement coupled to an electric axial flux machine. The transmission arrangement and the electric axial flux machine form a structural unit. This can be formed, for example, by means of a drive train housing, in which the transmission arrangement and the electric axial flux machine are accommodated together.

The electric machine preferably has a motor housing and/or the transmission has a transmission housing, wherein the structural unit can then be implemented by fixing the transmission in relation to the electric machine. The transmission housing is a housing for accommodating a transmission. It has the task of guiding existing shafts via the bearings and giving the wheels (possibly cam discs) the degrees of freedom they require under all loads without impeding their rotational and possible path movement, as well as absorbing bearing forces and supporting torques. A transmission housing can be designed as single-shell or multi-shell, i.e., undivided or divided. In particular, the transmission housing should be able to dampen noise and vibrations as well as safely absorb hydraulic fluid. The transmission housing is preferably formed from a metallic material, particularly preferably from aluminum, gray cast iron or cast steel, in particular by means of a primary shaping process such as casting or die-casting.

In particular, the transmission arrangement can be coupled to the electric machine, which is designed to generate a drive torque for the motor vehicle. The drive torque is particularly preferably a main drive torque, such that the motor vehicle is driven exclusively by the drive torque. The transmission arrangement is preferably designed as a planetary transmission, very particularly preferably as a shiftable, in particular two-speed planetary transmission.

Finally, the object of the disclosure can also be achieved by a motor vehicle having a first electric axle drive train on a first vehicle axle and a second electric axle drive train on a second vehicle axle. In particular, this makes it possible for each vehicle wheel of a two-axle motor vehicle to be driven by an axial flux machine assigned to it in each case.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

### BRIEF DESCRIPTION OF THE DRAWINGS

The disclosure is explained in more detail below with reference to drawings without limiting the general concept of the disclosure.

In the drawings:

FIG. 1 shows a schematic hydraulic block diagram of an axial flux machine in an axial sectional view,

FIG. 2 shows an axle drive train having two axial flux machines in an axial sectional view,

FIG. 3 shows a first embodiment of hydraulic lines and paths of the axial flux machine in an exposed cross-sectional view,

FIG. 4 shows a second embodiment of hydraulic lines and paths of the axial flux machine in an exposed cross-sectional view,

FIG. 5 shows a first cross-sectional view of the motor housing of the axial flux machine,

FIG. 6 shows a second cross-sectional view of the motor housing of the axial flux machine,

FIG. 7 shows a third cross-sectional view of the motor housing of the axial flux machine,

FIG. 8 shows a motor vehicle having two electrically drivable vehicle axles in a schematic block diagram.

### DETAILED DESCRIPTION

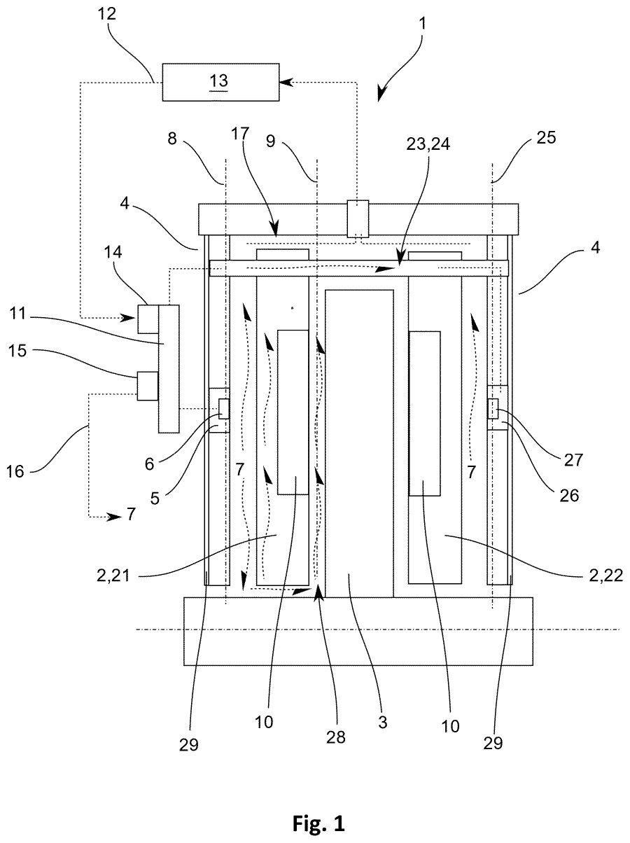

FIG. 1 shows an axial flux machine 1, comprising a rotor 3 rotatably mounted relative to a stator 2, wherein the stator 2 has a first disc-shaped stator body 21, and the rotor 3 and also the first stator body 21 are arranged such that a first magnetically effective gap 28 running in a radial plane 9 is formed axially between the first stator body 21 and the rotor 3.

The stator 2 is surrounded at least in sections by a motor housing 4. A ring-segment-shaped groove 5 which is open towards the first stator body 21 and extends in a radial plane 8 is formed on the motor housing 4. A plurality of cooling openings 6 are provided in the motor housing 4 in the region of the ring-segment-shaped groove 5, by means of which cooling openings a cooling fluid 7 that can be introduced into the ring-segment-shaped groove 5 can be applied to the first stator body 21. Here, the number of cooling openings 6 corresponds to the number of coils 10 of the first stator body 21. As indicated in FIG. 1, the cooling fluid 7 can also flow around the coils 10, for example by providing corresponding channels in the stator body 21. In this regard, the cooling openings 6 for the cooling fluid 7 are selected such that the most efficient cooling of the coils 10 and the stator bodies 21, 22 can be ensured.

For installation space reasons, the two axial flux machines 1 are arranged directly and immediately axially adjacent to one another. The axial flux machine 1 is thus cooled here using a cooling fluid 7, which is pumped through the heat exchanger 13 by a pump, not shown, from a sump, also not shown.

FIG. 1 further shows that the stator 2 comprises a second disc-shaped stator body 22, which is arranged coaxially to the first stator body 21 and spaced apart from the first stator body 21 with axial interposition of the rotor 3, wherein the cooling channel section 11 is connected at least to a first hydraulic path 23 extending axially through the axial flux machine 1, so that the cooling fluid 7 can be guided to the second disc-shaped stator body 22. The axial flux machine 1 further comprises a second hydraulic path 24 extending axially through the axial flux machine 1 and connected to the cooling channel section 11.

FIG. 1 also shows that a second ring-segment-shaped groove 26 which is open towards the second stator body 22 and extends in a radial plane 25 is formed on the motor housing 4, and a plurality of cooling openings 27 are provided in the motor housing 4 in the region of the second ring-segment-shaped groove 26, by means of which cooling openings a cooling fluid 7 that can be introduced into the second ring-segment-shaped groove 26 can be applied to the second stator body 22, wherein the second groove 26 is connected to the first hydraulic path 23 and/or the second hydraulic path 24.

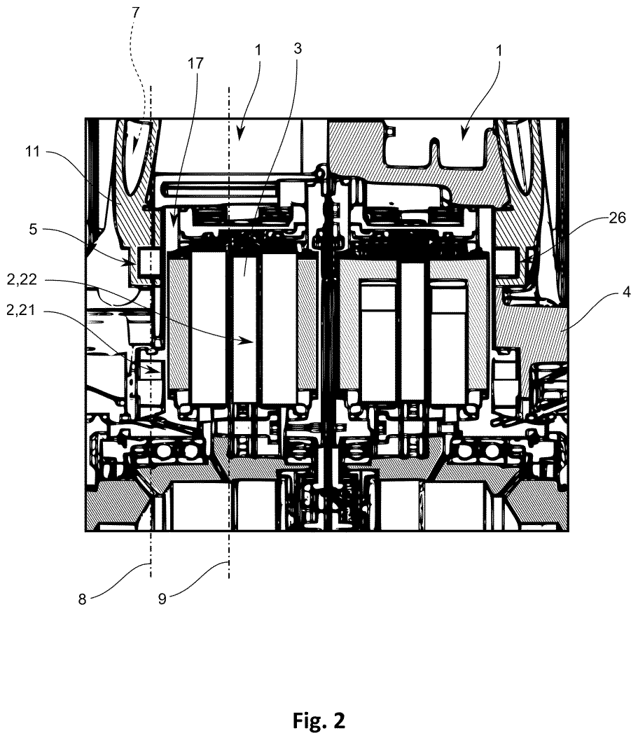

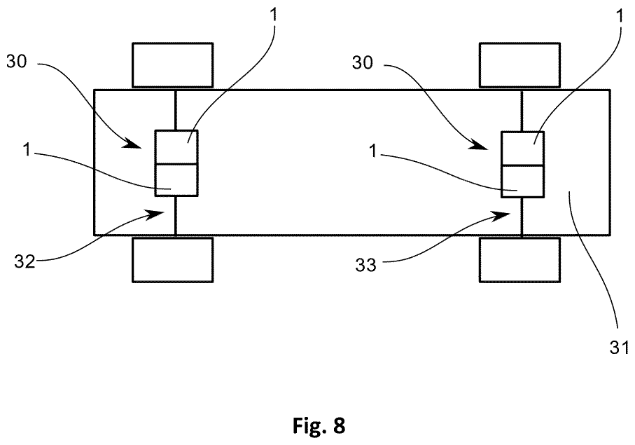

FIG. 2 shows a section of an electrically operable axle drive train 30, such as can be installed in the front axle 33 of a motor vehicle 31, which is sketched in an exemplary manner in FIG. 8. In this exemplary embodiment, two independent axial flux machines 1 are installed, which are structured in a mirrored manner. In the example shown, such an axle drive train 30 consists in each case of an axial flux machine 1 with a transmission arrangement assigned to it, but not visible in FIG. 2.

As can be seen from FIG. 8, the rear axle 32 of a motor vehicle 31 can, in turn, also consist of two mirrored and independent systems, as shown in FIG. 2. Preferably, the axial flux machines 1 in the motor vehicle 31 are designed essentially identically.

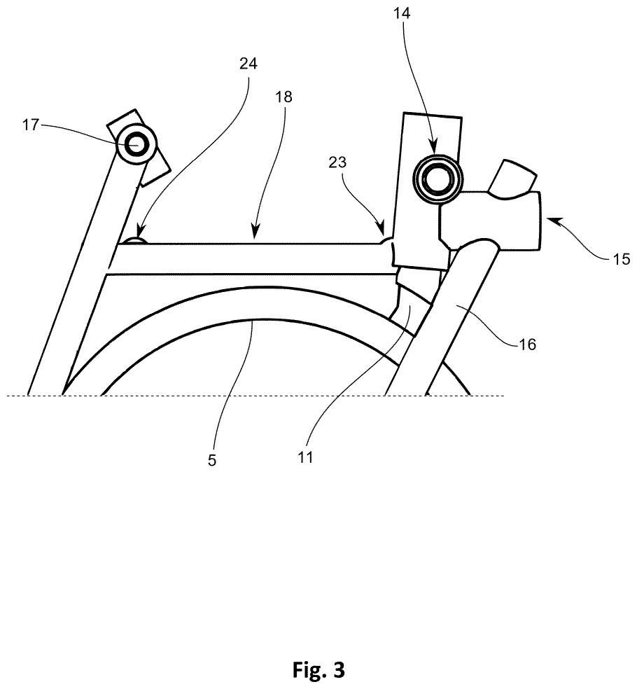

FIG. 3 schematically shows the oil distribution channels of the axial flux machine 1, comprising the ring-segment-shaped groove 5. From the output side 12 of the heat exchanger 13, a cooling channel section 11 leads into the ring-segment-shaped groove 5, which is arranged on the transmission side but designed to be open towards the axial flux machine 1. The oil line in the ring-segment-shaped groove 5 is only indicated here by way of example. In order to improve the uniform distribution of the cooling fluid 7, it is expedient, for example, to arrange a channel 18 between the hydraulic paths 23, 24 and thereby connect them hydraulically. FIG. 3 shows an embodiment without this channel 18. In principle, it would also be conceivable for the ring-segment-shaped groove 5 to not run in a closed manner between the hydraulic paths 23, 24 in the circumferential direction, unlike as is shown in FIG. 3, but to be interrupted between the hydraulic paths 23, 24.

From the ring-segment-shaped groove 5, two outlets lead upwards in the radial direction to the axially running hydraulic paths 23,24 in order to allow for the oil cooling of the second stator body 22 on the side of the axial flux machine 1 facing away from the transmission.

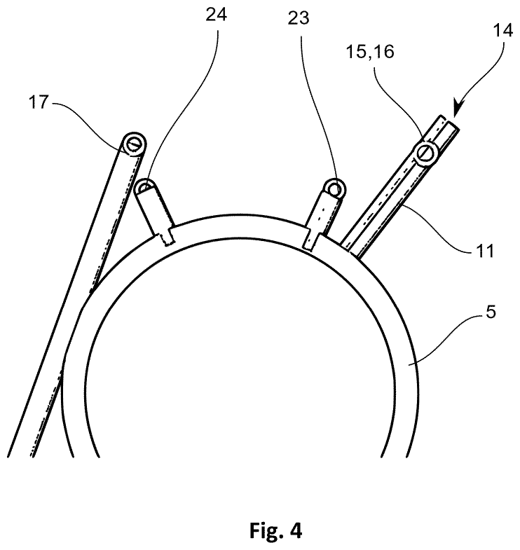

Furthermore, the return channel 17 from the axial flux machine 1 can be seen in FIG. 4, which taps the cooling fluid 7 at the highest point of the axial flux machine 1 in the direction of gravity and directs it into the sump, which is not described in more detail.

Via the height in the direction of gravity of the feed point (outlet 12 of the heat exchanger 13) or the highest point of the cooling channel section 11 in the direction of gravity and the height of the cooling openings 6 in the direction of gravity, it is possible to adjust the oil level in the axial flux machine 1 even at low/stopped volume flows. This prevents the axial flux machine from overheating.

The volume flow can also be used to supply other components at the same time, for example via a series or parallel connection. In this case, further components (gear teeth, bearings, etc.) are supplied with cooling fluid via orifices after the axial flux machine. The distribution and pressure can be adjusted via the orifices, also in the outlet to the sump. However, this is not shown in the figures.

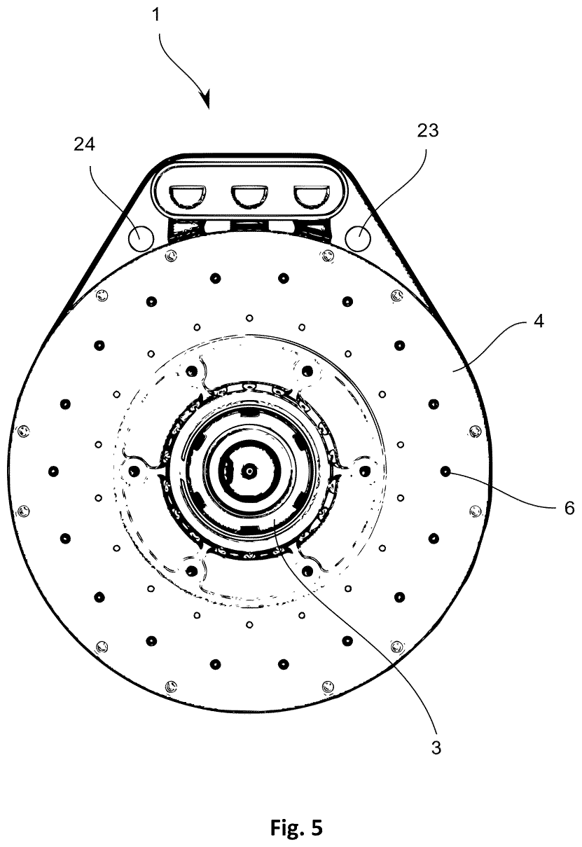

FIG. 5 shows a cross-sectional view of an axial flux machine 1 according to the disclosure. On the transmission side, several axially running cooling openings 6 are provided in the motor housing 4 here, which guide the cooling fluid 7 to the first stator body 21 of the stator 2 on the transmission side.

The two hydraulic paths 23, 24 are located in the region of the electrical connections, not described in more detail, in order to cool the second stator body 22 facing away from the transmission. The outlets from the ring-segment-shaped groove 5 are sealed here with connecting pieces to the axial flux machine 1. Naturally, it is also conceivable that seals can be fitted directly in the motor housing 4 at the outlets or on the axial flux machine 1, or even that a low amount of leakage can be tolerated.

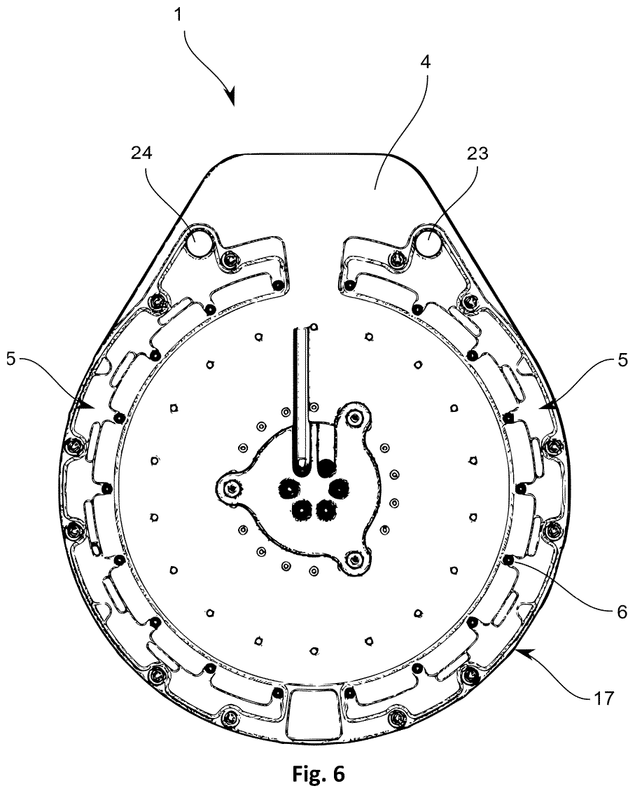

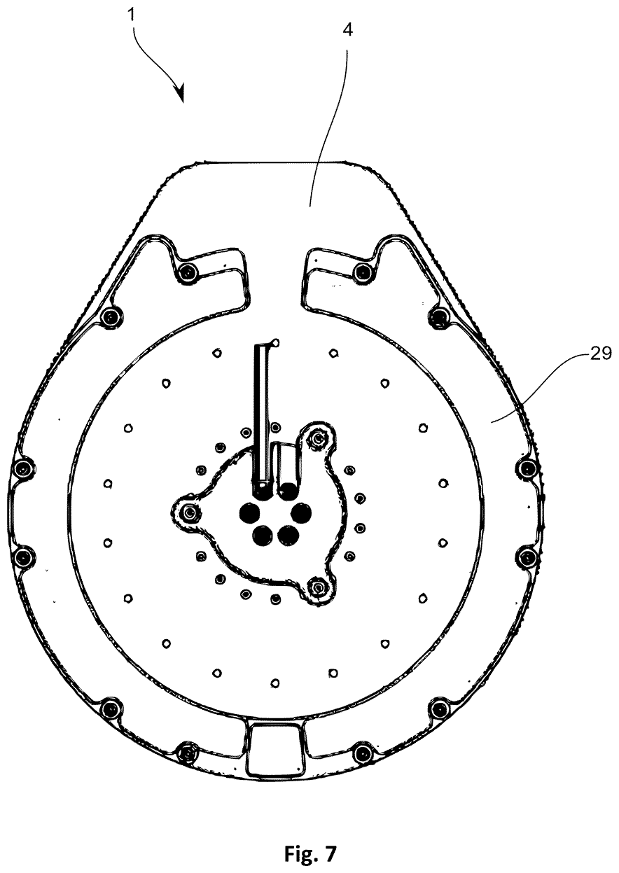

FIGS. 6 and 7 show the cross-sectional side of the axial flux machine 1 facing away from the transmission. FIG. 7 shows the motor housing 4 of the axial flux machine 1 closed by means of a sealing element 29 and FIG. 6 shows the open motor housing 4 without the sealing element 29. The cooling openings 27 are located under the sealing element 29, which again guide the oil supply into the second stator body 22, where it cools the winding heads etc. and can then flow off with the return flow from the second stator body 22 on the transmission side in a groove-like return channel 17 on the outer diameter of the stator 2. In order to be able to distribute the cooling fluid 7 from the two hydraulic paths 23, 24 to the individual cooling openings 27, a contour or channel structures is/are provided under the sealing element 29, which distribute/s the cooling fluid 7 in the circumferential direction.

Both volume flows of cooling fluid 7 from the two stator bodies 21, 22 (stator bodies 21, 22 on the transmission side and facing away from the transmission) are combined in the return channel 17. The cooling fluid 7 from the two stator bodies 21, 22 therefore flows together in the return channel 17 on the circumference of the stator 2 and is discharged from there at the highest point in the direction of gravity and fed to the sump.

The distribution of cooling fluid 7 and supply through the transmission housing is thus achieved within an axle drive train 30 for the first stator body on the transmission side and the oil distribution is implemented internally in the motor housing 4 of the axial flux machine 1 for the second stator body 22 facing away from the transmission.

As shown in FIGS. 3 and 4, the ring-segment-shaped groove 5 is hydraulically connected in a conducting manner to a cooling channel section 11 extending outwards in the radial direction, which in turn is hydraulically connected to the output side 12 of a heat exchanger 13 via a hydraulic coupling means 14.

FIGS. 3-4 furthermore show that a return channel 17 is formed radially above the first stator body 21, by means of which cooling fluid 7 can be discharged from the first stator body 21.

As shown in the embodiment of FIG. 3, a pressure relief valve 15 is arranged between the ring-segment-shaped groove 5 and the hydraulic coupling means 14, which opens into an overflow channel 16 on the output side.

Finally, FIG. 8 shows a motor vehicle 31 having a first electric axle drive train 30, as known from FIG. 2, on a first vehicle axle 32 and a second electric axle drive train 30, as known from FIG. 2, on a second vehicle axle 33.

The disclosure is not limited to the embodiments shown in the drawings. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SYMBOLS

1 Axial flux machine
2 Stator
3 Rotor
4 Motor housing
5 Groove
6 Cooling openings
7 Cooling fluid
8 Radial plane
9 Radial plane
10 Coils
11 Cooling channel section
12 Output side
13 Heat exchanger
14 Coupling means
15 Pressure relief valve
16 Overflow channel
17 Return channel
18 Channel
21 Stator body
22 Stator body
23 Hydraulic path
24 Hydraulic path
25 Radial plane
26 Groove
27 Cooling openings
28 Gap
29 Sealing element
30 Axle drive train
31 Motor vehicle
32 Vehicle axle
33 Vehicle axle

1. An axial flux machine, comprising:
a rotor rotatably mounted relative to a stator, wherein the stator has at least one first disc-shaped stator body, and the rotor and also the first stator body are arranged such that a first magnetically effective gap running in a radial plane is formed axially between the first stator body and the rotor, and the stator is surrounded at least in sections by a motor housing,
wherein a ring-segment-shaped groove which is open towards the first stator body and extends in a radial plane is formed on the motor housing, and a plurality of cooling openings are provided in the motor housing in a region of the ring-segment-shaped groove, by means of which cooling openings a cooling fluid that can be introduced into the ring-segment-shaped groove can be applied to the first stator body.

2. The axial flux machine according to claim 1, wherein:
a number of cooling openings corresponds to a number of coils of the first stator body.

3. The axial flux machine according to claim 1, wherein:
the ring-segment-shaped groove is hydraulically connected in a conducting manner to a cooling channel section extending outwards in the radial direction, which in turn is hydraulically connected to an output side of a heat exchanger via a hydraulic coupling means.

4. The axial flux machine according to claim 3, wherein:
a pressure relief valve is arranged between the ring-segment-shaped groove and the hydraulic coupling means, which opens into an overflow channel on the output side.

5. The axial flux machine according to claim 1, wherein:
a return channel is formed radially outside of the first stator body, by means of which cooling fluid can be discharged from the first stator body.

6. The axial flux machine according to claim 3, wherein:
the stator comprises at least one second disc-shaped stator body, which is arranged coaxially to the first stator body and spaced apart from the first stator body with axial interposition of the rotor, wherein the cooling channel section is connected at least to a first hydraulic path extending axially through the axial flux machine, so that the cooling fluid can be guided to the second disc-shaped stator body.

7. The axial flux machine according to claim 6, wherein:
the axial flux machine has a second hydraulic path extending axially through the axial flux machine and connected to the cooling channel section.

8. The axial flux machine according to claim 7, further comprising:
a second ring-segment-shaped groove which is open towards the second stator body and extends in a radial plane is formed on the motor housing, and a plurality of cooling openings are provided in the motor housing and/or on a connecting housing of superordinate structure in the region of the second ring-segment-shaped groove, by means of which cooling openings a cooling fluid that can be introduced into the second ring-segment-shaped groove can be applied to the second stator body, wherein the second groove is connected to the first hydraulic path and/or the second hydraulic path.

9. An electric axle drive train for a motor vehicle, comprising at least two axial flux machines, according to claim 1, the rotors of which are arranged coaxially to one another.

10. A motor vehicle having a first electric axle drive train according to claim 9 on a first vehicle axle and a second electric axle drive train according to claim 9 on a second vehicle axle.
